(19) United States
(12) Patent Application Publication
(10) Pub. No.: US 2023/0177331 A1
(43) Pub. Date: Jun. 8, 2023

(54) METHODS OF TRAINING DEEP LEARNING MODEL AND PREDICTING CLASS AND ELECTRONIC DEVICE FOR PERFORMING THE METHODS

(71) Applicant: ELECTRONICS AND TELECOMMUNICATIONS RESEARCH INSTITUTE, Daejeon (KR)

(72) Inventors: Young Ho JEONG, Daejeon (KR); Soo Young PARK, Daejeon (KR); Tae Jin LEE, Daejeon (KR)

(21) Appl. No.: 18/060,405

(22) Filed: Nov. 30, 2022

(30) Foreign Application Priority Data
Dec. 2, 2021 (KR) 10-2021-0170694

(51) Int. Cl. G06N 3/08

(52) U.S. Cl. CPC G06N 3/08

(57) ABSTRACT

Disclosed are methods of training a deep learning model and predicting a class and an electronic device for performing the methods. A method of training a deep learning model may include identifying training data labeled for each class, determining whether to augment the training data based on overall recognition performance indicating prediction accuracy of the deep learning model calculated in a previous epoch, augmenting the training data based on class-specific recognition performance indicating class-specific prediction accuracy of the deep learning model calculated in the previous epoch, predicting a class by inputting the training data or the training data that is augmented to the deep learning model according to a determination of whether to augment the training data, and training the deep learning model based on a labeled class and the predicted class.

### CROSS-REFERENCE TO RELATED APPLICATION

This application claims the benefit of Korean Patent Application No. 10-2021-0170694 filed on Dec. 2, 2021, at the Korean Intellectual Property Office, the entire disclosure of which is incorporated herein by reference for all purposes.

### BACKGROUND

### 1. Field of the Invention

One or more embodiments relate to methods of training a deep learning model and predicting a class and an electronic device for performing the methods.

### 2. Description of the Related Art

Acoustic recognition technology may be divided into acoustic event recognition technology and acoustic scene recognition technology according to an object to be recognized. Individual acoustic objects, such as a fire alarm, a scream, a vehicle horn sound, that appear and disappear at a specific time, are defined as an acoustic event, and a unique spatial acoustic characteristic created by a combination of individual acoustic objects that may occur in a specific place such as an airport, a shopping mall, and a restaurant is defined as an acoustic scene.

To develop a deep neural network model for recognizing an acoustic event or acoustic scene, acoustic data for training the deep neural network model is needed. Acoustic data needs to be collected under various conditions such as through a plurality of devices, in multiple recording places, and at different recording times to allow a trained deep learning model to provide consistent recognition performance in a real environment.

However, most acoustic data used to develop an acoustic event or acoustic scene recognition model is collected under limited conditions. When operating in a real environment where various conditions exist, an acoustic event or acoustic scene recognition model developed using only original acoustic data that is collected under limited conditions has less performance than performance achieved when the model was being developed.

### SUMMARY

Embodiments provide a method of training a deep learning model and an electronic device that may enhance the recognition performance of a deep learning model, for example, an acoustic event recognition model or an acoustic scene recognition model, and prevent the recognition performance from deteriorating in a real environment by adaptively applying a data augmentation technique in a process of training a deep learning model based on recognition performance evaluation metrics to enhance the recognition performance of a deep learning model trained using training data collected under limited conditions.

According to an aspect, there is provided a method of training a deep learning model including identifying training data labeled for each class, determining whether to augment the training data based on overall recognition performance indicating prediction accuracy of a deep learning model calculated in a previous epoch, augmenting the training data based on class-specific recognition performance indicating class-specific prediction accuracy of the deep learning model calculated in the previous epoch according to a determination of whether to augment the training data, predicting a class by inputting the training data or the training data that is augmented to the deep learning model according to the determination of whether to augment the training data, and training the deep learning model based on a labeled class and the predicted class.

The determining of whether to augment the training data may include determining that the training data is to be augmented in response to the overall recognition performance being greater than a first threshold that is set.

The augmenting of the training data may include calculating a second threshold using the overall recognition performance, a maximum value of the class-specific recognition performance and a scale factor that determines a reflection ratio of the overall recognition performance and the maximum value of the class-specific recognition performance, and augmenting the training data of a class with the class-specific recognition performance less than the second threshold.

The calculating of the second threshold may include calculating the second threshold by increasing a reflection ratio of the maximum value of the class-specific recognition performance as the scale factor increases and by increasing a reflection ratio of the overall recognition performance as the scale factor decreases.

The augmenting of the training data of the class with the class-specific recognition performance less than the second threshold may include calculating an application probability based on the second threshold and the class-specific recognition performance, and determining whether to augment each piece of the training data based on the application probability.

The calculating of the application probability may include calculating the application probability for the each class based on a value obtained by subtracting the class-specific recognition performance from the second threshold.

The method of training the deep learning model may further include updating the overall recognition performance and the class-specific recognition performance using validation data for evaluating performance of the deep learning model, and determining whether to terminate training of the deep learning model based on the overall recognition performance that is updated and the overall recognition performance calculated in the previous epoch.

The training data may include acoustic data labeled with an acoustic event corresponding to individual acoustic objects or acoustic data labeled with an acoustic scene corresponding to a combination of the individual acoustic objects, and the deep learning model is trained to predict the acoustic event or the acoustic scene by inputting the acoustic data.

According to an aspect, there is provided a method of predicting a class including identifying input data and a trained deep learning model, and predicting a class of the identified input data by inputting the identified input data to the deep learning model, wherein, the deep learning model may be trained by identifying the training data labeled for each class, determining whether to augment the training data based on overall recognition performance indicating prediction accuracy of the deep learning model calculated in a previous epoch, augmenting the training data based on class-specific recognition performance indicating class-specific prediction accuracy of the deep learning model calculated in the previous epoch according to a determination of whether to augment the training data, predicting a class by inputting the training data or the training data that is augmented to the deep learning model according to a determination of whether to augment the training data, and the training is based on a labeled class and the predicted class.

The deep learning model may be trained based on a determination that the training data is to be augmented in response to the overall recognition performance being greater than a first threshold that is set.

The deep learning model may be trained by calculating a second threshold using the overall recognition performance, a maximum value of the class-specific recognition performance, and a scale factor that determines a reflection ratio of the overall recognition performance and the maximum value of the class-specific recognition performance, and augmenting the training data of a class with the class-specific recognition performance less than the second threshold.

The deep learning model may be trained by calculating the second threshold by increasing a reflection ratio of the maximum value of the class-specific recognition performance as the scale factor increases and by increasing a reflection ratio of the overall recognition performance as the scale factor decreases.

The deep learning model may be trained by calculating an application probability based on the second threshold and the class-specific recognition performance, and determining whether to augment the training data based on the application probability.

According to an aspect, there is provided an electronic device including a processor, wherein the processor may be configured to identify input data and a trained deep learning model and predict a class of the identified input data by inputting the identified input data to the deep learning model, and the deep learning model may be trained by identifying the training data labeled for each class, determining whether to augment the training data based on overall recognition performance indicating prediction accuracy of the deep learning model calculated in a previous epoch, augmenting the training data based on class-specific recognition performance indicating class-specific prediction accuracy of the deep learning model calculated in the previous epoch according to a determination of whether to augment the training data, predicting a class by inputting the training data or the training data that is augmented to the deep learning model according to a determination of whether to augment the training data, and the training is based on a labeled class and the predicted class.

The deep learning model may be trained based on a determination that the training data is to be augmented in response to the overall recognition performance being greater than a first threshold that is set.

The deep learning model may be trained by calculating a second threshold using the overall recognition performance, a maximum value of the class-specific recognition performance, and a scale factor that determines a reflection ratio of the overall recognition performance and the maximum value of the class-specific recognition performance, and augmenting the training data of a class with the class-specific recognition performance less than the second threshold.

The deep learning model may be trained by calculating the second threshold by increasing a reflection ratio of the maximum value of the class-specific recognition performance as the scale factor increases and by increasing a reflection ratio of the overall recognition performance as the scale factor decreases.

The deep learning model may be trained by calculating an application probability based on the second threshold and the class-specific recognition performance, and determining whether to augment the training data based on the application probability.

The deep learning model may be trained by calculating the application probability for the each class based on a value obtained by subtracting the class-specific recognition performance from the second threshold.

Additional aspects of embodiments will be set forth in part in the description which follows and, in part, will be apparent from the description, or may be learned by practice of the disclosure.

According to embodiments, recognition performance of a deep learning model may be enhanced, and performance deviations between classes to be recognized may be reduced.

According to embodiments, an acoustic scene recognition model or an acoustic event recognition model trained based on an adaptive data augmentation technique may enhance recognition performance in a real environment and may be applicable in various application fields such as avoidance of dangerous situations, facility security monitoring, media automatic tagging, situational awareness, environmental noise monitoring, and equipment condition monitoring for the elderly and infirm, hearing impaired, and smart cars.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a schematic block diagram illustrating an electronic device that trains a deep learning model according to an embodiment;

FIG. 2 is a diagram illustrating an operation of an electronic device to train a deep learning model according to an embodiment;

FIG. 3 is a diagram illustrating an operation of an electronic device to augment training data according to an embodiment;

FIG. 4 is a diagram illustrating an operation of an electronic device to repeatedly train a deep learning model according to an embodiment;

FIG. 5 is a diagram illustrating an operation of an electronic device to augment each piece of training data using class-specific recognition performance of the training data according to an embodiment;

FIG. 6 is a diagram illustrating an operation of an electronic device to augment training data based on an application probability according to an embodiment; and

FIG. 7 is a diagram illustrating an operation of an electronic device to predict a class of input data using a trained deep learning model according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

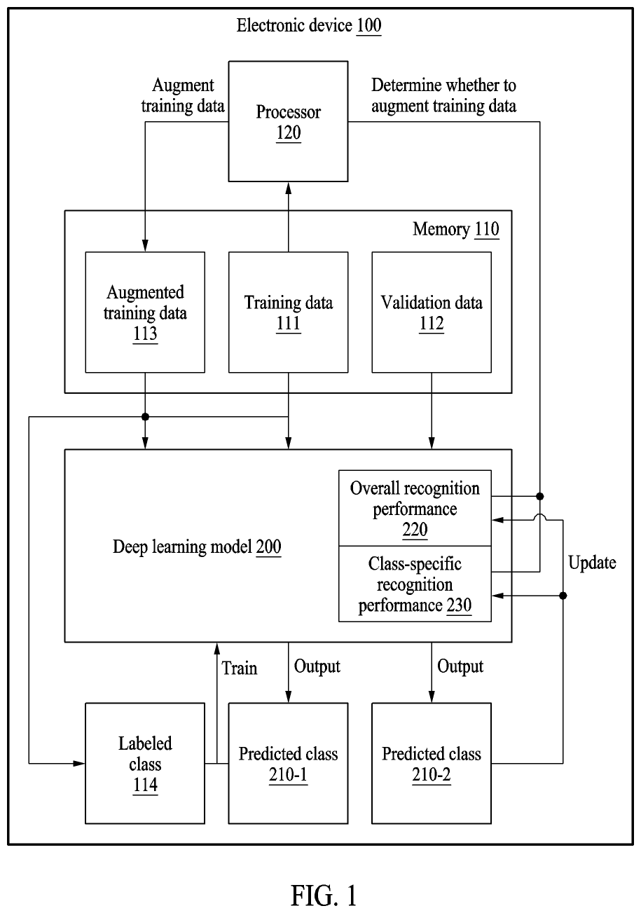

FIG. 1 is a schematic block diagram illustrating an electronic device 100 that trains a deep learning model 200 according to an embodiment.

Referring to FIG. 1, the electronic device 100 according to various embodiments may include a memory 110, a processor 120, or the deep learning model 200. For example, the electronic device 100 may train the deep learning model 200 using training data 111 and validation data 112 stored in the memory 110.

According to various embodiments, the processor 120 may be electrically connected to the memory 110 and/or the processor 120, input the training data 111 or the validation data 112 stored in the memory 110 to the deep learning model 200, and output a predicted class 210. For example, the processor 120 may augment the training data 111 and store augmented training data 113 in the memory 110.

For example, the memory 110 may store the training data 111, the validation data 112, and the augmented training data 113. For example, the training data 111 and the validation data 112 stored in the memory 110 may be a dataset for training the deep learning model 200. For example, the memory 110 may store test data (not shown) for testing the deep learning model 200 that is trained.

For example, the training data 111 may be used to update a weight of the deep learning model 200, and the validation data 112 may be used to calculate overall recognition performance 220 and class-specific recognition performance 230 of the deep learning model 200.

For example, a set of the training data 111 stored in the memory 110, for example, the training data 111, the validation data 112, or the test data may be acoustic data labeled with an acoustic event or an acoustic scene. For example, an acoustic event may refer to an individual acoustic object that appears and disappears at a specific time such as a fire alarm, a scream, and a vehicle horn sound. For example, an acoustic scene may be a unique spatial acoustic characteristic created by a combination of individual acoustic objects that may occur in a specific place such as an airport, a shopping mall, and a restaurant.

For example, if the training data 111, the validation data 112, or the test data is the acoustic data labeled with the acoustic event, the acoustic data may be divided into classes such as a fire alarm, a scream, and a vehicle horn sound. For example, if the training data 111, the validation data 112, or the test data is the acoustic data labeled with the acoustic scene, the acoustic data may be divided into classes such as airport, shopping mall, and restaurant.

For example, the deep learning model 200 may be a neural network model, to which various known neural network models may be applied. For example, the neural network model may include a plurality of artificial neural network layers. An artificial neural network may include one of a deep neural network (DNN), a convolutional neural network (CNN), a recurrent neural network (RNN), a restricted Boltzmann machine (RBM), a deep belief network (DBN), and a bidirectional recurrent deep neural network (BRDNN), and a deep Q-network, but examples are not limited thereto. The neural network model may additionally or alternatively include a software structure other than a hardware structure.

For example, the deep learning model 200 may output the predicted class 210 by inputting the training data 111 or the validation data 112 that is labeled for each class. For example, if the training data 111 or the validation data 112 is the acoustic data labeled with the acoustic event, the electronic device 100 may predict and output a class, such as fire alarm, scream, and vehicle horn, with which the acoustic data is labeled by inputting the training data 111 or the validation data 112 to the deep learning model 200. For example, if the training data 111 or the validation data 112 is the acoustic data labeled with the acoustic scene, the electronic device 100 may predict and output a class, such airport, shopping mall, and restaurant, with which the acoustic data is labeled by inputting the training data 111 or the validation data 112 to the deep learning model 200.

The electronic device 100 according to various embodiments may identify the training data 111 that is labeled for each class. For example, the processor 120 of the electronic device 100 may identify the training data 111 stored in the memory 110. The training data 111 stored in the memory 110 may be labeled for each class. For example, the electronic device 100 may recognize batch-wise training data 111.

For example, the processor 120 of the electronic device 100 may identify the overall recognition performance 220 and the class-specific recognition performance 230 of the deep learning model 200 calculated in a previous epoch. For example, the overall recognition performance 220 of the deep learning model 200 may be performance with respect to predicting a labeled class 114 using input data and may be calculated using the predicted class 210 that is output as a result of inputting the validation 112 to the deep learning model 200.

For example, the electronic device 100 may update a weight of the deep learning model 200 using the training data 111 in the previous epoch and output the predicted class 210 by inputting the validation 112 to the deep learning model 200 in which the weight is updated. The electronic device 100 may calculate the overall recognition performance 220 and the class-specific recognition performance 230 of the deep learning model 200 using the predicted class 210 that is output as a result of inputting the validation data 112 to the deep learning model 200.

For example, the overall recognition performance 220 and the class-specific recognition performance 230 of the deep learning model 200 may be calculated according to a scheme of evaluating performance of the deep learning model 200 that is trained, such as accuracy, recall, precision, and F1 score.

For example, the electronic device 100 may set a scheme of evaluating the performance of the deep learning model 200 differently according to labeling of the training data 111 and the validation data 112. For example, if the training data 111 and the validation data 112 is the acoustic data labeled with the acoustic event, the electronic device 100 may calculate the overall recognition performance 220 and the class-specific recognition performance 230 of the deep learning model 200 according to a scheme of calculating an F1 score.

For example, if the training data 111 and the validation data 112 is the acoustic data labeled with the acoustic scene, the electronic device 100 may calculate the overall recognition performance 220 and the class-specific recognition performance 230 of the deep learning model 200 depending on a scheme of calculating accuracy.

For example, the overall recognition performance 220 of the deep learning model 200 may be performance with respect to prediction accuracy of the deep learning model 200 that is calculated using the overall validation data 112, and the class-specific recognition performance 230 of the deep learning model 200 may be performance with respect to prediction accuracy of the deep learning model 200 that is calculated for each class among the validation data 112.

For example, the electronic device 100 may identify the overall recognition performance 220 and the class-specific recognition performance 230 indicating the prediction accuracy of the deep learning model 200 calculated in the previous epoch.

According to various embodiments, as shown in Equation 1 below, the electronic device 100 may calculate the overall recognition performance 220 using an average of the class-specific recognition performance 230 of the deep learning model 200.

$${P}_{model} = \frac{1}{N} {\sum }_{i = 1}^{N} {P}_{i} . \qquad [ Equation 1 ]$$

In Equation 1, P_{model} may denote the overall recognition performance 220 of the deep learning model 200, and Pᵢ may denote recognition performance of an i-th class among a total of N classes.

The electronic device 100 may determine whether to augment the training data 111 based on the overall recognition performance 220 indicating the prediction accuracy of the deep learning model 200 calculated in the previous epoch. For example, the electronic device 100 may determine whether to augment the batch-wise training data 111, for example, batch-wise acoustic data.

For example, the electronic device 100 may determine whether to augment the training data 111 according to Equation 2 below. For example, the electronic device 100 may determine that the training data 111 is to be augmented in response to the overall recognition performance 220 being greater than a first threshold that is set. For example, the first threshold may be, for the deep learning model 200 being trained, a threshold of the overall recognition performance 220 in which adaptive data augmentation that augments data may operate effectively according to the prediction accuracy, for example, the overall recognition performance 220 and the class-specific recognition performance 230, of the deep learning model 200.

P_{model}>Pₜₕ₁ [Equation 2]

In Equation 2, P_{model} may denote the overall recognition performance 220 of the deep learning model 200, and Pₜₕ₁ may denote the first threshold.

In response to a determination that the training data 111 is to be augmented, the electronic device 100 may augment the training data 111 based on the class-specific recognition performance 230 calculated in the previous epoch. For example, the electronic device 100 may augment the training data 111 for each class according to the class-specific recognition performance 230. For example, the electronic device 100 may perform data augmentation on the training data 111 included in classes with the class-specific recognition performance 230 less than a second threshold.

Pᵢ<Pₜₕ₂·(1≤i≤N) [Equation 3]

In Equation 3, Pᵢ may denote recognition performance of the i-th class among the total of N classes, and Pₜₕ₂ may denote the second threshold.

For example, based on Equation 4 below, the electronic device 100 may calculate the second threshold using the overall recognition performance 220 of the deep learning model 200 calculated in the previous epoch, a maximum value of the class-specific recognition performance 230, and a scale factor for determining a reflection ratio of the overall recognition performance 220 and the maximum value of the class-specific recognition performance 230.

Pₜₕ₂=(1−≥)·P_{model}+∝·max(Pᵢ) [Equation 4]

In Equation 4, Pₜₕ₂ may denote the second threshold, ∝ may denote the scale factor, P_{model} may denote the overall recognition performance 220, and max(Pᵢ) may denote the maximum value of the class-specific recognition performance 230. For example, the scale factor ∝ may be determined within a range of 0 or more and less than 1.

Referring to Equation 4, the electronic device 100 may calculate the second threshold by increasing a reflection ratio of the maximum value of the class-specific recognition performance 230 as the scale factor increases and by increasing a reflection ratio of the overall recognition performance 220 as the scale factor decreases. For example, in Equation 4, the second threshold Pₜₕ₂ may indicate that the reflection ratio of the maximum value max(Pᵢ) of the class-specific recognition performance 230 increases as the scale factor ∝ becomes closer to 1. Conversely, if the scale factor ∝ is 0, the second threshold Pₜₕ₂ may be identical to the overall recognition performance 220 P_{model}.

Referring to Equation 3 and Equation 4, the electronic device 100 may calculate the second threshold using the overall recognition performance 220, the maximum value of the class-specific recognition performance 230, and the scale factor as shown in Equation 4 and may augment the training data 111 of a class with class-specific recognition performance 230 less than the second threshold.

According to various embodiments, the electronic device 100 may augment the training data 111 according to the application probability. For example, the electronic device 100 may perform data augmentation on each piece of the training data 111 included in the class with class-specific recognition performance 230 less than the second threshold according to the application probability.

For example, the electronic device 100 may augment the training data 111 based on an application probability value β(0≤β≤1). For example, the electronic device 100 may generate a random value having a uniform distribution at an interval from 0 to 1 and augment the training data 111 in response to an application probability βᵢ being greater than the random value. For example, in response to there being N pieces of the training data 111 included in the class with recognition performance less than the second threshold, the electronic device 100 may generate a random value having the uniform distribution on the interval from 0 to 1 for each of the N pieces of the training data 111. The electronic device 100 may compare the generated random value with the application probability βᵢ to perform data augmentation on the training data 111 having the application probability βᵢ greater than the random value.

For example, the electronic device 100 may calculate the application probability based on the second threshold and the class-specific recognition performance 230. For example, the electronic device 100 may determine that the application probability βᵢ is proportional to (Pₜₕ₂−Pᵢ) obtained by subtracting the class-specific recognition performance 230 from the second threshold. For example, the electronic device 100 may determine that the application probability βᵢ varies depending on each class.

The electronic device 100 may set a probability of applying a data augmentation scheme to the training data 111 differently depending on the class-specific recognition performance 230 of the deep learning model 200 by setting the application probability βᵢ to be proportional to (Pₜₕ₂−Pᵢ) obtained by subtracting the class-specific recognition performance 230 from the second threshold. For example, among pieces of the training data 111 divided into classes from 1 to N, if recognition performance Pᵢ of a class i is greater than recognition performance Pⱼ of a class j, an application probability for the training data 111 included in the class i may be less than an application probability of the training data 111 included in the class j.

According to various embodiments, the electronic device 100 may augment the training data 111 to generate the augmented training data 113. For example, the electronic device 100 may store the augmented training data 113 that is generated in the memory 110. For example, the electronic device 100 may apply, to the training data 111, a data augmentation scheme (e.g., mix-up, random cropping, reverberation, speed change, random noise, DRC (Dynamic Range Compression), SpecAugment, etc.) that modifies the training data 111 and increases a number of pieces of the training data 111.

According to the description of an operation of augmenting the training data 111, the electronic device 100 may determine whether to augment the training data 111 identified based on Equation 2, for example, the batch-wise training data 111. The electronic device 100 may calculate the second threshold based on Equation 4, compare the second threshold with the class-specific recognition performance 230 of the batch-wise training data 111, and determine a class for which the training data 111 is to be augmented. The electronic device 100 may calculate the application probability for each class for which the training data 111 is to be augmented, compare a random value generated according to the uniform distribution at the interval from 0 to 1 for each of the pieces of the training data 111 included in a class with the application probability, and determine whether to perform data augmentation on each of the pieces of the training data 111 included in the class.

According to various embodiments, the electronic device 100 may predict a class by inputting the training data 111 or the augmented training data 113 to the deep learning model 200 according to a determination of whether to augment the training data 111. For example, when the training data 111 includes the acoustic data labeled with the acoustic event corresponding to the individual acoustic object or the acoustic data labeled with the acoustic scene corresponding to the combination of the individual acoustic objects, the deep learning model 200 may be trained to predict the acoustic event or the acoustic scene included in the acoustic data by inputting the acoustic data.

For example, when the identified training data 111 does not satisfy Equation 2, for example, when the overall recognition performance 220 of the deep learning model 200 is greater than the first threshold, the electronic device 100 may output the predicted class 210 by inputting the training data 111 to the deep learning model 200.

For example, when the identified training data 111 satisfies Equation 2, and the training data 111 is augmented according to the application probability for the training data 111 included in a class that satisfies Equation 3, the electronic device 100 may output the predicted class 210 by inputting the augmented training data 113 to the deep learning model 200.

According to various embodiments, the electronic device 100 may train the deep learning model 200 based on the labeled class 114 and the predicted class 210. The electronic device 100 may train the deep learning model 200 by comparing the labeled class 114 of the training data 111 and the predicted class 210 output from the deep learning model 200.

For example, the electronic device 100 may perform forward propagation of the deep learning model 200 by inputting the training data 111 or the augmented training data 113 to the deep learning model 200 and may calculate a loss value that is a difference between a value predicted by the deep learning model 200 and a ground truth, for example, a difference between the predicted class 210 output from the deep learning model 200 and the labeled class 114 of the training data 111. The electronic device 100 may train the deep learning model 200 by performing backward propagation of the deep learning model 200 that updates a weight value of the deep learning model 200 in a way that decreases the calculated loss value.

According to various embodiments, the electronic device 100 may update the overall recognition performance 220 and the class-specific recognition performance 230 of the deep learning model 200 using the validation data 112. The electronic device 100 may determine whether to augment the training data 111 in substantially the same way as the above-described operation of the electronic device 100 and train the deep learning model 200 using the overall recognition performance 220 and the class-specific recognition performance 230 updated during the training of the deep learning model 200 in a next epoch.

The operation of training the deep learning model 200 by applying the data augmentation scheme to the training data 111 according to the overall recognition performance 220 and the class-specific recognition performance 230 of the deep learning model 200 calculated in the previous epoch is described above. The electronic device 100 may perform the above-described operation in the previous or next epoch in substantially the same manner.

According to various embodiments, the electronic device 100 may determine whether to terminate the training of the deep learning model 200 based on the updated overall recognition performance 220 of the deep learning model 200 and the overall recognition performance 220 calculated in the previous epoch. For example, when the overall recognition performance 220 of the deep learning model 200 is no longer improved even when a number of iterations of training of the deep learning model 200 increases, for example, even when the number of epoch increases, the electronic device 100 may terminate the training of the deep learning model 200 even when the number of training iterations has not reached the set number of epochs. For example, the electronic device 100 may determine whether to terminate the training of the deep learning model 200 by setting a condition in which the overall recognition performance 200 of the deep learning model 200 does not improve even when the number of times training is performed increases and comparing the set condition with a difference between the overall recognition performance 220 of the deep learning model 200 in the previous epoch and a current epoch.

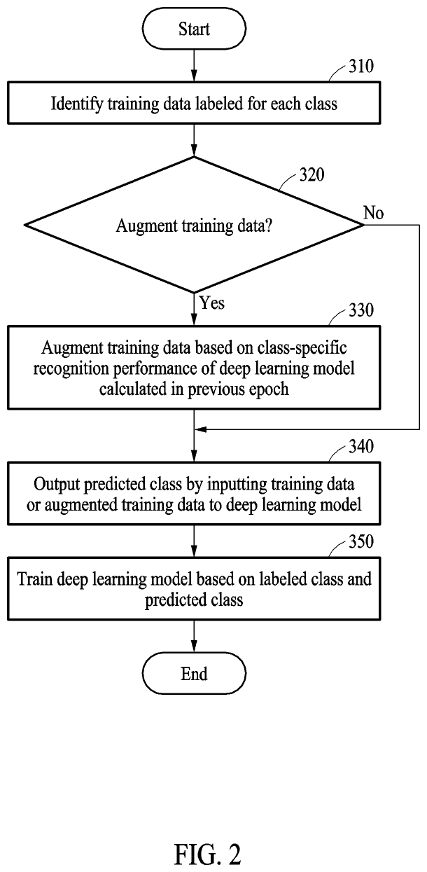

FIG. 2 is a diagram illustrating an operation of the electronic device 100 to train the deep learning model 200 according to an embodiment.

Referring to FIG. 2, in operation 310, the electronic device 100 may identify the training data 111 labeled for each class. For example, the electronic device 100 may identify batch-wise training data 111.

In operation 320, the electronic device 100 may determine whether to augment the training data 111. For example, in response to the overall recognition performance 220 of the deep learning model 200 calculated in a previous epoch being greater than a first threshold, the electronic device 100 may determine that the training data 111 is to be augmented.

For example, the electronic device 100 may calculate the overall recognition performance 220 and the class-specific recognition performance 230 related to prediction accuracy using the deep learning model 200 trained with the training data 111 in a previous epoch, for example, the deep learning model 200 in which a weight is updated. For example, the electronic device 100 may calculate the class-specific recognition performance 230 of the deep learning model 200 according to a scheme of evaluating performance of the deep learning model 200 such as accuracy, recall, precision, and F1 score. The electronic device 100 may calculate the overall recognition performance 220 using an average of class-specific recognition performance 230.

For example, the first threshold may be a threshold of recognition performance at which a scheme of augmenting the training data 111 according to the overall recognition performance 220 and/or the class-specific recognition performance 230 for the deep learning model 200 being trained, for example, an adaptive data augmentation scheme, may operate effectively. The first threshold may be determined according to a user setting.

In operation 330, the electronic device 100 may augment the training data 111 based on the class-specific recognition performance 230 of the deep learning model 200 calculated in the previous epoch. For example, the electronic device 100 may augment the training data 111 included in a class with class-specific recognition performance 230 less than a second threshold. The electronic device 100 may determine the second threshold based on the overall recognition performance 220 of the deep learning model 200, a maximum value of class-specific recognition performance 230 of the deep learning model 200, and a scale factor. For example, the scale factor may be a reflection ratio of the overall recognition performance 220 of the deep learning model 200 and a reflection ratio of the maximum value of the class-specific recognition performance 230 of the deep learning model 200 related to the second threshold.

For example, in operation 330, the electronic device 100 may augment the training data 111 based on an application probability. For example, the electronic device 100 may generate a random value according to a uniform distribution at an interval from 0 to 1 and augment the training data 111 in response to the application probability being greater than or equal to the random value.

For example, the electronic device 100 may determine an application probability for each class based on a value obtained by subtracting the class-specific recognition performance 230 from the second threshold. The electronic device 100 may augment the training data 111 based on the application probability such that the training data 111 may be augmented according to different application probabilities depending on the class-specific recognition performance 230 for each piece of the training data 111 included in a class with class-specific recognition performance 230 less than the second threshold.

In operation 340, the electronic device 100 may output the predicted class 210 by inputting the training data 111 or the augmented training data 113 to the deep learning model 200. For example, in response to a determination in operation 320 that the training data 111 is not to be augmented, the electronic device 100 may input the training data 111 to the deep learning model 200 in operation 340. For example, in response to a determination in operation 320 that the training data 111 is to be augmented, the electronic device 100 may input the augmented training data 113 to the deep learning model 200 in operation 340.

For example, the training data 111 may be acoustic data labeled with an acoustic event which is an individual acoustic object or acoustic data labeled with an acoustic scene which is a combination of individual acoustic objects. For example, the deep learning model 200 may be a neural network model that is trained to predict an acoustic event or an acoustic scene by inputting acoustic data.

In operation 350, the electronic device 100 may train the deep learning model 200 based on the labeled class 114 of the training data 111 and the predicted class 210 output from the deep learning model 200. For example, in operation 340, the electronic device 100 may perform forward propagation by inputting the training data 111 or the augmented training data 113 to the deep learning model 200. In operation 350, the electronic device 100 may calculate a loss based on a difference between the labeled class 114 and the predicted class 210, update a weight of the deep learning model 200 by performing backward propagation to minimize the loss, and train the deep learning model 200.

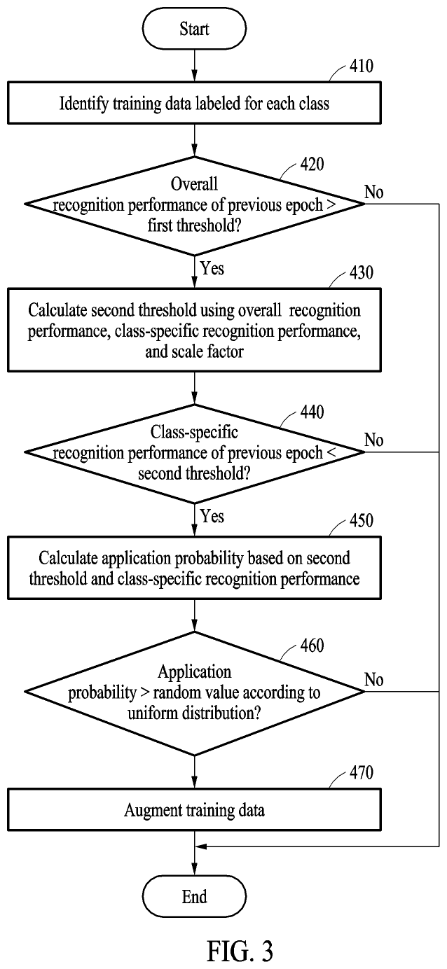

FIG. 3 is a diagram illustrating an operation of the electronic device 100 to augment the training data 111 according to an embodiment. FIG. 3 is a diagram illustrating operations of the electronic device 100 to determine whether to augment the training data 111 and augment the training data 111 according to an application probability for each class. For example, operations of FIG. 3 may be understood as operations that describe operations 320 and 330 of FIG. 2 in detail.

Referring to FIG. 3, in operation 410, the electronic device 100 may identify the training data 111 labeled for each class.

In operation 420, the electronic device 100 may compare the overall recognition performance 220 of the deep learning model 200 calculated in a previous epoch with a first threshold. For example, in response to the overall recognition performance 220 being greater than or equal to the first threshold, the electronic device 100 may determine that the training data 111 is to be augmented.

For example, the electronic device 100 may calculate the overall recognition performance 220 and the class-specific recognition performance 230 of the deep learning model 200 using the validation data 112 in the previous epoch. For example, the first threshold may be a threshold of recognition performance at which a data augmentation scheme that augments the training data 111 operates effectively.

In operation 430, the electronic device 100 may calculate a second threshold using the overall recognition performance 220, a maximum value of the class-specific recognition performance 230, and a scale factor. For example, as shown in Equation 4, the electronic device 100 may determine the second threshold by increasing a reflection ratio of the maximum value of the class-specific recognition performance 230 as the scale factor increases and by increasing a reflection ratio of the overall recognition performance 220 as the scale factor decreases.

In operation 440, the electronic device 100 may compare the class-specific recognition performance 230 calculated in the previous epoch with the second threshold. For example, the electronic device 100 may determine that the training data 111 included in a class with class-specific recognition performance 230 less than the second threshold is to be augmented.

In operation 450, the electronic device 100 may determine the application probability based on the second threshold and the class-specific recognition performance 230. For example, the application probability may be determined to be proportional to a value obtained by subtracting the class-specific recognition performance 230 from the second threshold. For example, the electronic device 100 may determine the application probability for each class.

In operation 460, the electronic device 100 may compare the application probability with a random value. For example, the random value may be a random value generated according to a uniform distribution on an interval from 0 to 1. For example, the electronic device 100 may generate a random value corresponding to each piece of the training data 111 included in the class with class-specific recognition performance 230 less than the second threshold. In response to the generated random value being less than the application probability, the electronic device 100 may determine that the training data 111 corresponding to the random value is to be augmented.

In operation 470, the electronic device 100 may augment the training data 111. For example, the electronic device 100 may generate the augmented training data 113 by applying a data augmentation scheme (e.g., mix-up, random cropping, reverberation, speed change, random noise, DRC, SpecAugment, etc.) to the training data 111.

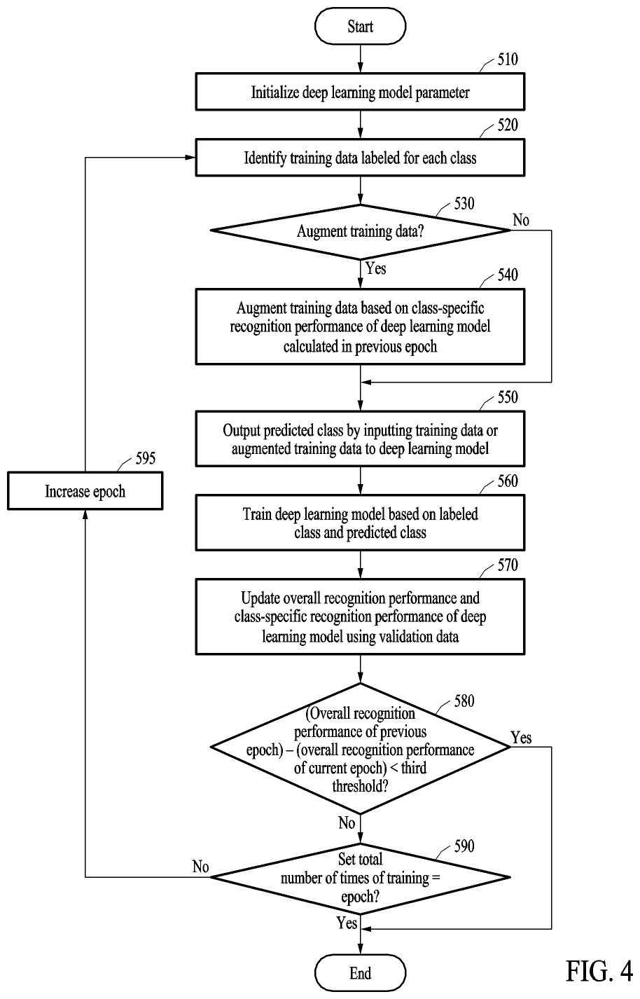

FIG. 4 is a diagram illustrating an operation of the electronic device 100 to repeatedly train the deep learning model 200 according to an embodiment.

Referring to FIG. 4, in operation 510, the electronic device 100 may initialize a parameter of the deep learning model 200. For example, the electronic device 100 may initialize a parameter such as a weight of the deep learning model 200, the overall recognition performance 220, or the class-specific recognition performance 230. For example, the electronic device 100 may initialize the class-specific recognition performance 230 to 0.

In operation 520, the electronic device 100 may identify the training data 111 labeled for each class. In operation 530, the electronic device 100 may determine whether to augment the training data 111.

In operation 540, the electronic device 100 may determine whether to augment the training data 111 based on the class-specific recognition performance 230 of the deep learning model 200 calculated in a previous epoch.

In operation 550, the electronic device 100 may output the predicted class 210 by inputting the training data 111 or the augmented training data 113 to the deep learning model 200. For example, in operation 560, the electronic device 100 may train the deep learning model 200 based on the labeled class 114 and the predicted class 210.

The description of operations of FIGS. 2 and 3 may apply to operation 530, operation 540, and operation 550 illustrated in FIG. 4 in substantially the same manner. For example, the description of operation 310 of FIG. 2 and operation 410 of FIG. 3 may apply to operation 520 of FIG. 4 in substantially the same manner.

In operation 570, the electronic device 100 may update the overall recognition performance 220 and the class-specific recognition performance 230 of the deep learning model 200 using the validation data 112. For example, the electronic device 100 may calculate the class-specific recognition performance 230 according to a scheme of evaluating performance of the deep learning model 200 such as accuracy, recall, precision, and F1 score. The electronic device 100 may determine whether to augment data based on the class-specific recognition performance 230 and the overall recognition performance 220 updated in a next epoch or determine the second threshold, a third threshold, and an application probability, and augment the training data 111 according to the class-specific recognition performance 230.

In operation 580, the electronic device 100 may compare a difference between the overall recognition performance 220 of the previous epoch and the overall recognition performance 220 of a current epoch with the third threshold. For example, the third threshold may be a criterion that is used to determine whether the overall recognition performance 220 of the deep learning model 200 increases as a number of epochs increases, for example, as the number of times the deep learning model 200 is trained increases. For example, the third threshold may be set by a user or set to an initial value.

For example, in operation 580, in response to the difference between the overall recognition performance 220 of the previous epoch and the overall recognition performance 220 of the current epoch being less than the third threshold, for example, in response to a determination that the overall recognition performance 220 of the deep learning model 200 is not improving, the electronic device 100 may terminate the training of the deep learning model 200.

In operation 580, in response to the difference between the overall recognition performance 220 of the previous epoch and the overall recognition performance 220 of the current epoch being greater than the third threshold, for example, in response to a determination that the overall recognition performance 220 of the deep learning model 200 is improving, the electronic device 100 may compare a total set number of times training is to be performed with the number of epochs in operation 590. In operation 580, the electronic device 100 may determine whether the deep learning model 200 is repeatedly trained the total set number of times.

In operation 580, in response to a total number of times training is performed being different from the number of epochs, the electronic device 100 may increase the number of epochs by 1 in operation 590. After performing operation 590, the electronic device 100 may repeatedly perform operations 520 through 590. For example, in operation 580, the electronic device 100 may train the deep learning model 200 by repeating operations 520 through 590 until it is determined that the overall recognition performance 220 of the deep learning model 200 is not improving or that the deep learning model 200 is has been repeatedly trained the total set number of times in operation 590.

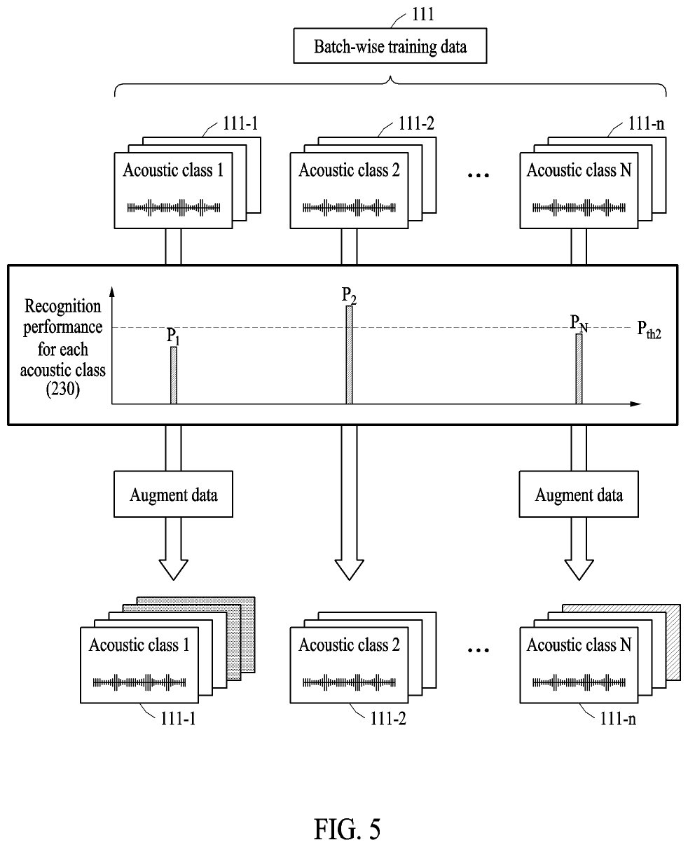

FIG. 5 is a diagram illustrating an operation of the electronic device 100 to augment each piece of the training data 111 using the class-specific recognition performance 230 of the training data 111 according to an embodiment.

FIG. 5 is a diagram illustrating an embodiment, among various embodiments, in which the training data 111 includes acoustic data. In FIG. 5, the electronic device 100 may identify pieces of batch-wise training data 111-1 through 111-n from the training data 111. For example, the identified pieces of the batch-wise training data 111-1 through 111-n may be acoustic data labeled for each class. As illustrated in FIG. 5, the pieces of the batch-wise training data 111-1 through 111-n may be pieces of acoustic data that are labeled into N classes such as acoustic class one 111-1, acoustic class two 111-2, . . . , and acoustic class N 111-n.

Referring to FIG. 5, the electronic device 100 may augment training data based on the class-specific recognition performance 230 and a second threshold.

For example, the electronic device may compare the class-specific recognition performance 230 Pᵢ (1≤i≤N) with the second threshold Pₜₕ₂. The electronic device may determine that training data included in a class with class-specific recognition performance 230 Pᵢ less than the second threshold Pₜₕ₂ is to be augmented.

For example, as illustrated in FIG. 5, recognition performance P₁ of an acoustic class one and recognition performance P_{N} of an acoustic class N may be less than the second threshold Pₜₕ₂, and recognition performance P₂ of an acoustic class two may be greater than the second threshold Pₜₕ₂.

For example, the electronic device 100 may determine that the pieces of the training data 111-1 and 111-n respectively included in the acoustic class one and the acoustic class N are to be augmented. The electronic device may generate augmented training data 113-1 of the acoustic class one and augmented training data 113-n of the acoustic class N by applying a data augmentation scheme to the training data 111-1 included in the acoustic class one and the training data 111-n included in the acoustic class N. The electronic device may not augment training data 111-2 included in the acoustic class two because recognition performance P₂ of the acoustic class two is greater than the second threshold Pₜₕ₂.

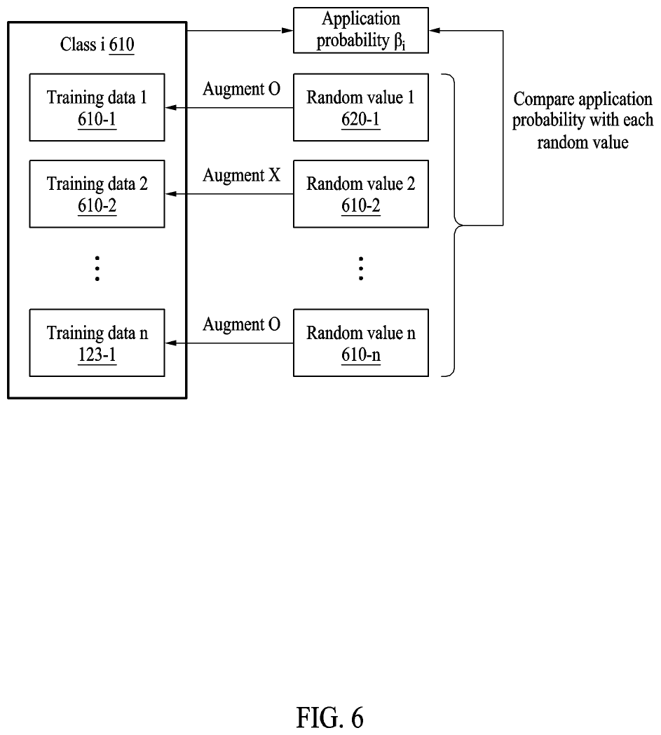

FIG. 6 is a diagram illustrating an operation of the electronic device 100 to augment training data based on an application probability according to an embodiment.

In FIG. 6, an application probability βᵢ may be applied to pieces of training data 610-1 through 610-n labeled with a class i 610. In FIG. 6, the electronic device may determine the application probability βᵢ based on recognition performance of the class i 610 and a second threshold. FIG. 6 illustrates a case in which the recognition performance of the class i 610 is less than the second threshold and the electronic device determines that the pieces of the training data 610-1 through 610-n included in the class i 610 are to be augmented.

Referring to FIG. 6, the electronic device 100 may augment the pieces of the training data 610-1 through 610-n based on the application probability.

For example, in FIG. 6, the electronic device 100 may generate random values 620-1 through 620-n respectively corresponding to the pieces of the training data one 610-1 through n 610-n labeled with the class i 610. For example, the electronic device 100 may generate the random values one 620-1 through n 620-n respectively corresponding to the pieces of the training data one 610-1 through n 610-n using a uniform distribution on an interval from 0 to 1.

For example, the electronic device 100 may determine whether to augment the pieces of the training data one 610-1 through n 610-n by comparing the determined application probability βᵢ with the generated random values 1 620-1 through n 620-n. FIG. 6 illustrates an embodiment in which the random value one 620-1 and the random value n 620-n are less than the application probability βᵢ and a random value two 620-2 is greater than the application probability βᵢ.

As illustrated in FIG. 6, the electronic device 100 may perform data augmentation on the training data one 610-1 and the training data n 610-n among the pieces of the training data one 610-1 through n 610-n labeled with the class i 610, because the random value one 620-1 and the random value n 620-n respectively corresponding to the training data one 610-1 and the training data n 610-n are less than the application probability βᵢ. The electronic device 100 may not augment the training data two 610-2 because the random value two 620-2 is greater than the application probability βᵢ.

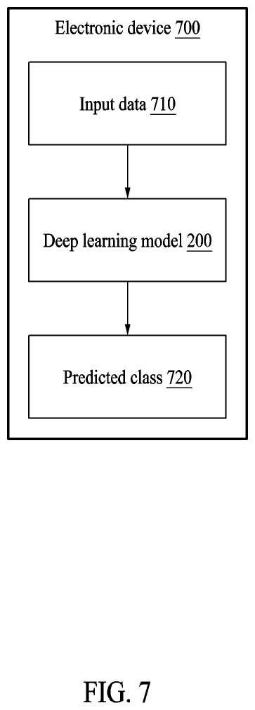

FIG. 7 is a diagram illustrating an operation of an electronic device 700 to predict a class of input data 710 using the deep learning model 200 that is trained according to an embodiment.

Referring to FIG. 7, the electronic device 700 may include a processor (not shown), and the processor of the electronic device 700 may identify the input data 710 and the deep learning model 200 that is trained. The electronic device may predict a class of the input data by inputting the input data 710 to the deep learning model 200. For example, a predicted class 720 may be output from the deep learning model 200 of the electronic device 700.

For example, the class of the input data 710 may be labeling of the training data 111 used in a process of training the deep learning model 200. For example, when the training data 111 is acoustic data labeled with an acoustic event, the input data may be the acoustic data. The electronic device 700 may predict the acoustic event of the input data 710, for example, output the predicted class 720, by inputting the input data 710 to the deep learning model 200.

The deep learning model 200 illustrated in FIG. 7 may be trained according to the electronic device 100 or the method of training the deep learning model described with reference to FIGS. 1 through 6. For example, the deep learning model 200 illustrated in FIG. 7 may be a model trained by determining whether to augment training data, determining whether to augment training data for each class according to the overall recognition performance 220 and the class-specific recognition performance 230 of the deep learning model 200 calculated in a previous epoch, and using the augmented training data 113 that is augmented for each piece of the training data 111 according to the an application probability.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Implementations of the various techniques described herein may be implemented in digital electronic circuitry, or in computer hardware, firmware, software, or in combinations thereof. Implementations may implemented as a computer program product, i.e., a computer program tangibly embodied in an information carrier, e.g., in a machine-readable storage device (computer-readable medium), for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory (ROM) or a random access memory (RAM), or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, for example, magnetic media such as hard disks, floppy disks, and magnetic tape, optical media such as compact disc ROMs (CD-ROMs) or digital versatile discs (DVDs), magneto-optical media such as floptical disks, ROMs, RAMs, flash memories, erasable programmable ROMs (EPROMs), or electrically erasable programmable ROMs (EEPROMs). The processor and the memory may be supplemented by, or incorporated in special purpose logic circuitry.

In addition, non-transitory computer-readable media may be any available media that may be accessed by a computer and may include both computer storage media and transmission media.

While the present specification contains many specific implementation details, these should not be construed as limitations on the scope of any disclosure or of what may be claimed, but rather as descriptions of features that may be specific to particular embodiments of particular disclosures. Specific features described in the present specification in the context of individual embodiments may also be combined and implemented in a single embodiment. On the contrary, various features described in the context of a single embodiment may be implemented in a plurality of embodiments individually or in any appropriate sub-combination. Moreover, although features may be described above as acting in specific combinations and even initially claimed as such, one or more features from a claimed combination can in some cases be excised from the combination, and the claimed combination may be changed to a sub-combination or a modification of a sub-combination.

Likewise, although operations are depicted in a predetermined order in the drawings, it should not be construed that the operations need to be performed sequentially or in the predetermined order, which is illustrated to obtain a desirable result, or that all of the shown operations need to be performed. In some cases, multi-tasking and parallel processing may be advantageous. In addition, it should not be construed that the division of various device components of the aforementioned embodiments is required in all types of embodiments, and it should be understood that the described program components and devices are generally integrated as a single software product or packaged into a multiple-software product.

The embodiments disclosed in the present specification and the drawings are intended merely to present specific examples in order to aid in understanding of the present disclosure, but are not intended to limit the scope of the present disclosure. It will be apparent to one of one of ordinary skill in the art that various modifications based on the technical spirit of the present disclosure, as well as the disclosed embodiments, can be made.

What is claimed is:

1. A method of training a deep learning model, the method comprising:
identifying training data labeled for each class;
determining whether to augment the training data based on overall recognition performance indicating prediction accuracy of a deep learning model calculated in a previous epoch;
augmenting the training data based on class-specific recognition performance indicating class-specific prediction accuracy of the deep learning model calculated in the previous epoch according to a determination of whether to augment the training data;
predicting a class by inputting the training data or the training data that is augmented to the deep learning model according to the determination of whether to augment the training data; and
training the deep learning model based on a labeled class and the predicted class.

2. The method of claim 1, wherein the determining of whether to augment the training data comprises determining that the training data is to be augmented in response to the overall recognition performance being greater than a first threshold that is set.

3. The method of claim 1, wherein the augmenting of the training data comprises:
calculating a second threshold using the overall recognition performance, a maximum value of the class-specific recognition performance and a scale factor that determines a reflection ratio of the overall recognition performance and the maximum value of the class-specific recognition performance; and
augmenting the training data of a class with the class-specific recognition performance less than the second threshold.

4. The method of claim 3, wherein the calculating of the second threshold comprises calculating the second threshold by increasing a reflection ratio of the maximum value of the class-specific recognition performance as the scale factor increases and by increasing a reflection ratio of the overall recognition performance as the scale factor decreases.

5. The method of claim 3, wherein the augmenting of the training data of the class with the class-specific recognition performance less than the second threshold comprises:
calculating an application probability based on the second threshold and the class-specific recognition performance; and
determining whether to augment each piece of the training data based on the application probability.

6. The method of claim 5, wherein the calculating of the application probability comprises calculating the application probability for the each class based on a value obtained by subtracting the class-specific recognition performance from the second threshold.

7. The method of claim 1, further comprising:
updating the overall recognition performance and the class-specific recognition performance using validation data for evaluating performance of the deep learning model; and
determining whether to terminate training of the deep learning model based on the overall recognition performance that is updated and the overall recognition performance calculated in the previous epoch.

8. The method of claim 1, wherein
the training data comprises acoustic data labeled with an acoustic event corresponding to individual acoustic objects or acoustic data labeled with an acoustic scene corresponding to a combination of the individual acoustic objects, and
the deep learning model is trained to predict the acoustic event or the acoustic scene by inputting the acoustic data.

9. A method of predicting a class, the method comprising:
identifying input data and a trained deep learning model; and
predicting a class of the identified input data by inputting the identified input data to the deep learning model,
wherein the deep learning model is trained by identifying the training data labeled for each class, determining whether to augment the training data based on overall recognition performance indicating prediction accuracy of the deep learning model calculated in a previous epoch, augmenting the training data based on class-specific recognition performance indicating class-specific prediction accuracy of the deep learning model calculated in the previous epoch according to a determination of whether to augment the training data, predicting a class by inputting the training data or the training data that is augmented to the deep learning model according to a determination of whether to augment the training data, and the training is based on a labeled class and the predicted class.

10. The method of claim 9, wherein the deep learning model is trained based on a determination that the training data is to be augmented in response to the overall recognition performance being greater than a first threshold that is set.

11. The method of claim 9, wherein the deep learning model is trained by calculating a second threshold using the overall recognition performance, a maximum value of the class-specific recognition performance, and a scale factor that determines a reflection ratio of the overall recognition performance and the maximum value of the class-specific recognition performance, and augmenting the training data of a class with the class-specific recognition performance less than the second threshold.

12. The method of claim 11, wherein the deep learning model is trained by calculating the second threshold by increasing a reflection ratio of the maximum value of the class-specific recognition performance as the scale factor increases and by increasing a reflection ratio of the overall recognition performance as the scale factor decreases.

13. The method of claim 11, wherein the deep learning model is trained by calculating an application probability based on the second threshold and the class-specific recognition performance, and determining whether to augment the training data based on the application probability.

14. An electronic device comprising:
a processor,
wherein the processor is configured to identify input data and a trained deep learning model and predict a class of the identified input data by inputting the identified input data to the deep learning model, and
wherein the deep learning model is trained by identifying the training data labeled for each class, determining whether to augment the training data based on overall recognition performance indicating prediction accuracy of the deep learning model calculated in a previous epoch, augmenting the training data based on class-specific recognition performance indicating class-specific prediction accuracy of the deep learning model calculated in the previous epoch according to a determination of whether to augment the training data, predicting a class by inputting the training data or the training data that is augmented to the deep learning model according to a determination of whether to augment the training data, and the training is based on a labeled class and the predicted class.

15. The electronic device of claim 14, wherein the deep learning model is trained based on a determination that the training data is to be augmented in response to the overall recognition performance being greater than a first threshold that is set.

16. The electronic device of claim 14, wherein the deep learning model is trained by calculating a second threshold using the overall recognition performance, a maximum value of the class-specific recognition performance, and a scale factor that determines a reflection ratio of the overall recognition performance and the maximum value of the class-specific recognition performance, and augmenting the training data of a class with the class-specific recognition performance less than the second threshold.

17. The electronic device of claim 16, wherein the deep learning model is trained by calculating the second threshold by increasing a reflection ratio of the maximum value of the class-specific recognition performance as the scale factor increases and by increasing a reflection ratio of the overall recognition performance as the scale factor decreases.

18. The electronic device of claim 16, wherein the deep learning model is trained by calculating an application probability based on the second threshold and the class-specific recognition performance, and determining whether to augment the training data based on the application probability.

19. The electronic device of claim 18, wherein the deep learning model is trained by calculating the application probability for the each class based on a value obtained by subtracting the class-specific recognition performance from the second threshold.
